(19) United States
(12) Patent Application Publication
(10) Pub. No.: US 2026/0288514 A1
(43) Pub. Date: Sep. 24, 2026

(54) PARALLELIZED COMPRESSED SPARSE ROW PREPROCESSING FOR GPU-BASED SPARSE MATRIX VECTOR MULTIPLICATION

(71) Applicant: Advanced Micro Devices, Inc., Santa Clara, CA (US)

(72) Inventors: Paul Fridtjof Trojahn, Gauting (DE); Fabian Robert Sebastian Wildgrube, Munich (DE); William Peter Ehrett, Austin, TX (US); Dominik Baumeister, Munich (DE)

(21) Appl. No.: 19/087,731

(22) Filed: Mar. 24, 2025

(51) Int. Cl. G06F 9/48

(52) U.S. Cl. CPC G06F 9/4881

(57) ABSTRACT

An apparatus and method for performing efficient dynamic scheduling of kernels in a processing circuit. In various implementations, a host processing circuit conveys to an accelerator device, an input vector and a representation of a sparse matrix for a matrix multiplication operation. To generate the output vector for the matrix multiplication operation, multiple compute circuits of the accelerator device overlap execution of multiple types of operations. Four types of operations include classifying operations that classify rows of the sparse matrix as short rows or long rows, matrix multiplication operations using long rows, partitioning operations that group short rows together for subsequent matrix multiplication operations, and matrix multiplication operations using short rows. To overlap the operations, the multiple compute circuits generate kernels without involvement from the host processing circuit. The multiple compute circuits convey the generated kernels to a scheduling queue of a control circuit of the accelerator device.

### BACKGROUND

### Description of the Relevant Art

The parallelization of tasks is used to increase the throughput of computing systems. To this end, compilers extract parallelized tasks from applications to execute in parallel on the system hardware. To increase parallel execution on the hardware, many different types of computing systems include vector processing circuits, which can include a parallel data processing circuit with multiple single-instruction, multiple-data (SIMD) circuits. Vector processing circuits, or SIMD circuits, include multiple parallel lanes of execution. Tasks can be executed in parallel on these types of parallel data processing circuits to increase the throughput of the computing system. The memory stores at least the instructions (or translated commands) of a parallel data application. The instructions are placed in kernels with one or more kernels corresponding to function calls in the parallel data application. These types of micro-architecture provide higher instruction throughput for parallel data applications than a general-purpose micro-architecture. Tasks that benefit from the SIMD micro-architecture are used in a variety of applications in a variety of fields such as medicine, entertainment, engineering, social media, science, finance, and so on.

The throughput of the parallel data micro-architecture is highly dependent on the instructions filling the pipeline stages of the parallel execution lanes of the vector processing circuits. When a pipeline stage does not receive an instruction to process, the pipeline stage has a stall, or a “bubble,” inserted in it and no useful work is performed for that pipeline stage. For example, sparse matrix vector multiplication (SpMV) operations use a sparse matrix and a dense vector as inputs. The number of non-zero elements in the rows of the sparse matrix can vary greatly. This variance creates inefficient use of the parallel lanes of execution of the vector processing circuits. Preprocessing steps performed by the host processing circuit that attempts to create groupings of contiguous non-zero elements for the matrix multiplication operations creates an appreciative delay before beginning the SpMV operations by the vector processing circuits.

In view of the above, methods and apparatuses for efficient dynamic scheduling of kernels in a processing circuit are desired.

### BRIEF DESCRIPTION OF THE DRAWINGS

FIG. 1 is a generalized diagram of sparse matrix processing that performs efficient dynamic scheduling of kernels in a processing circuit.

FIG. 2 is a generalized diagram of sparse matrix processing that performs efficient dynamic scheduling of kernels in a processing circuit.

FIG. 3 is a generalized diagram of an apparatus that performs efficient dynamic scheduling of kernels in a processing circuit.

FIG. 4 is a generalized diagram of a method for performing efficient dynamic scheduling of kernels in a processing circuit.

FIG. 5 is a generalized diagram of a method for performing efficient dynamic scheduling of kernels in a processing circuit.

FIG. 6 is a generalized diagram of a method for performing efficient dynamic scheduling of kernels in a processing circuit.

FIG. 7 is a generalized diagram of a method for performing efficient dynamic scheduling of kernels in a processing circuit.

FIG. 8 is a generalized diagram of a computing system that performs efficient dynamic scheduling of kernels in a processing circuit.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods for performing efficient dynamic scheduling of kernels in a processing circuit are disclosed. In various implementations, a host processing circuit conveys, to an accelerator device, an input vector and a representation of a sparse matrix for a matrix multiplication operation. The rows of the sparse matrix include a varying number of non-zero elements. A row of the sparse matrix is considered a long row, rather than a short row, when the number of non-zero elements of the row exceeds a threshold length (threshold number of non-zero elements in the row). In some implementations, the host processing circuit provides addresses that point to the data storage locations that store metadata that provide a representation of the sparse matrix. The representation consumes less data storage space than the actual sparse matrix. Using a parallel data microarchitecture, the accelerator device concurrently processes a subset of the total number of rows of the sparse matrix by concurrently classifying each of the rows of the subset as a long row or a short row. Next, using the parallel data microarchitecture, the accelerator device overlaps execution of four types of operations. The four types of operations include classifying operations that classify rows as short rows or long rows, matrix multiplication operations using long rows, partitioning operations that group short rows together for subsequent matrix multiplication operations, and the matrix multiplication operations using short rows. The overlapped execution of the four types of operations increases the throughput of the accelerator device and increases the performance of the parallel data application relying on the matrix multiplication that uses the input vector and the sparse matrix.

Typically, other processing circuits perform the above two types of operations in a serialized manner. The processing circuit classifies multiple rows of the total number of rows of the sparse matrix as a long row or a short row. Afterward, the processing circuit performs a partitioning operation that groups short rows together for subsequent matrix multiplication operations. Finally, the processing circuit performs the matrix multiplication operation for the long rows and the short rows. In some designs, the processing circuit includes multiple compute circuits and has the same compute circuit perform each of these operations for a corresponding row. However, the compute circuit is not optimized for the length of this corresponding row. The serialized manner and the unoptimized assignment of the row to the compute circuit lead to reduced performance.

In contrast to the inefficient execution of the matrix multiplication operation, the proposed solution includes a scheduler of the accelerator device that dispatches to a first compute circuit of the accelerator device, a first kernel to concurrently generate, by multiple execution lanes of the first compute circuit, a corresponding classification of each of the rows of the sparse matrix. Each of the multiple execution lanes executes a classification operation that compares the row lengths of rows to a length threshold to generate the corresponding classification of the row as a long row or a short row. The row length of a corresponding row is the number of non-zero elements in the corresponding row. A representation of the sparse matrix uses one of a variety of types of a data format (representation) for representing the sparse matrix such as the Coordinate (COO) data format, the Compressed Sparse Column (CSC) data format, and the Compressed Sparse Row (CSR) data format.

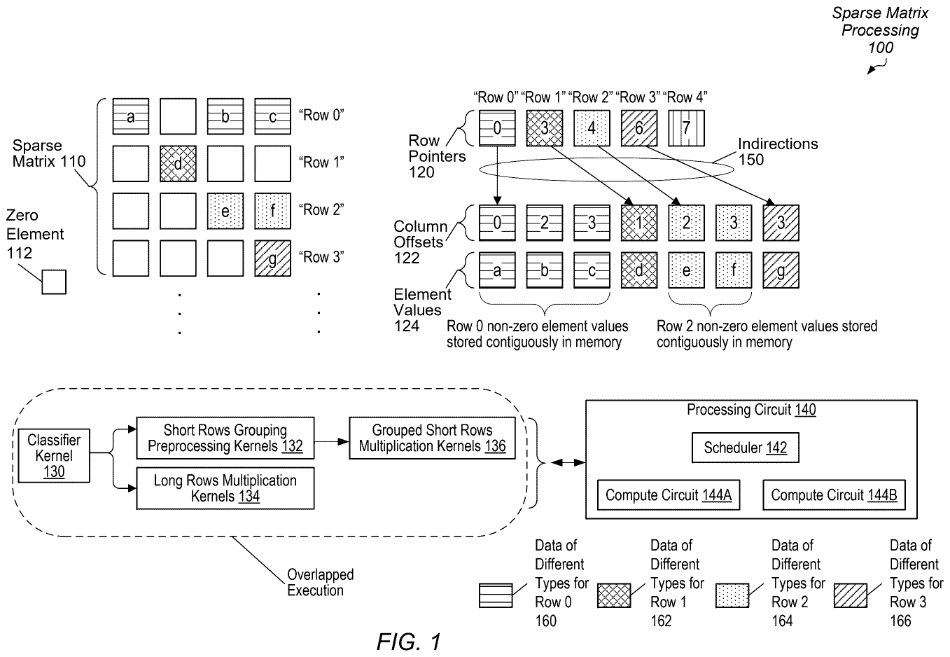

Next, the multiple compute circuits of the accelerator device overlap execution of four types of operations as described earlier. In an implementation, the compute circuits include hardware optimized for different row lengths and the scheduler assigns these operations to the compute circuits based on the row sizes of the corresponding rows of the sparse matrix. The overlapped execution of the four types of operations increases the throughput of the accelerator device and increases the performance of the parallel data application relying on the matrix multiplication that uses the input vector and the sparse matrix. The multiple compute circuits of the accelerator device generate an output vector that includes results of matrix multiplication operations using an input vector and the rows of the sparse matrix. Further details of these techniques for performing efficient dynamic scheduling of kernels in a processing circuit are provided in the following description of FIGS. 1-8.

Turning now to FIG. 1, a generalized diagram is shown of sparse matrix processing 100 that performs efficient dynamic scheduling of kernels in a processing circuit. As shown, sparse matrix 110 includes multiple rows, with one or more rows having a different number of non-zero elements than other rows. For sparse matrix 110, the non-zero elements are shown as shaded boxes, whereas the zero elements 112 are shown as unshaded boxes. The number of zero elements 112 and the number of non-zero elements vary for one or more rows of sparse matrix 110. A representation of sparse matrix 110 is provided by row pointers 120, column offsets 122 and element values 124. The shading of data 160 of sparse matrix 110 and the representation of sparse matrix 110 highlight data of different types corresponding to Row 0 of sparse matrix 110. For example, the non-zero elements of Row 0 of sparse matrix 110 use the shading of data 160. Similarly, the row indices (or row pointers) of row pointers 120 corresponding to Row 0 use the shading of data 160. The column offset values of column offsets 122 and the non-zero element values of element values 124 corresponding to Row 0 use the shading of data 160. The shading of data 162 of sparse matrix 110 and the representation of sparse matrix 110 highlight data of different types corresponding to Row 1 of sparse matrix 110. The shading of data 164 of sparse matrix 110 and the representation of sparse matrix 110 highlight data of different types corresponding to Row 2 of sparse matrix 110. The shading of data 166 of sparse matrix 110 and the representation of sparse matrix 110 highlight data of different types corresponding to Row 3 of sparse matrix 110.

The circuitry of processing circuit 140 includes scheduler 142 and multiple compute circuits such as at least compute circuit 144A and compute circuit 144B. In various implementations, processing circuit 140 performs a matrix multiplication operation using a dense vector (not shown) and sparse matrix 110. To do so efficiently, processing circuit 140 processes the sparse matrix 110 using classifier kernel 130, short rows grouping preprocessing kernels 132 (or preprocessing kernels 132), long rows multiplication kernels 134, and short rows multiplication kernels 136. The overlapped execution of the preprocessing kernels 132, the long rows multiplication kernels 134, and the short rows multiplication kernels 136 increase the throughput of processing circuit 140 and increases the performance of the parallel data application relying on the matrix multiplication that uses the dense vector and sparse matrix 110.

The rows of sparse matrix 110 have a varying number of non-zero elements between them. Therefore, the number of zero elements 112 and the number of non-zero elements vary across the rows. For sparse matrix 110, the non-zero elements are shown as shaded boxes, whereas the zero elements 112 are shown as unshaded boxes. The shading of boxes matches for non-zero elements of the same row. As used herein, the number of non-zero elements in a row is referred to as the “row length” of the row. For Row 0 of sparse matrix 110, the elements include the value “a” in the non-zero element 0 (column 0), the zero element 112 in element 1 (column 1), the value “b” in the non-zero element 2 (column 2), and the value “c” in the non-zero element 3 (column 3). The row length of Row 0 is 3 (or 3 non-zero elements). For Row 1 of sparse matrix 110, the elements include the zero element 112 in element 0 (column 0), the value “d” in the non-zero element 1 (column 1), and the zero element 112 in element 2 (column 2) and the zero element 112 in element 3 (column 3). The row length of Row 1 is 1 (or 1 non-zero element). For Row 2 of sparse matrix 110, the elements include the zero element 112 in element 0 (column 0) and element 1 (column 1), and the value “e” in the non-zero element 2 (column 2) and the value “f” in the non-zero element 3 (column 3). The row length of Row 2 is 2 (or 2 non-zero elements).

For Row 3 of sparse matrix 110, the elements include the zero element 112 in element 0 (column 0), element 1 (column 1), and element 2 (column 2), and the value “g” in the non-zero element 3 (column 3). The row length of Row 3 is 1 (or 1 non-zero element). Although four rows are shown and four elements per row are shown, another number of rows and elements per row are possible and contemplated based on design requirements. For example, in other implementations, sparse matrix 110 can include millions of rows and hundreds of elements per row or thousands of elements per row or tens of thousands of elements per row. Each of the values “a” through “g” of the non-zero elements can have one of a variety of numerical data formats such as an integer format or one of a variety of floating-point number formats.

Due to the varying number and large number of zero elements 112 in the rows of sparse matrix 110, sparse matrix 110 is preferably not stored in memory. Rather, a representation of sparse matrix 110 is stored in memory where the representation stores the values of non-zero elements in a contiguous manner in memory, which reduces the data storage requirement of sparse matrix 110. The representation also stores metadata that identifies the positions of the values of the non-zero elements in sparse matrix 110. For example, the metadata includes the corresponding row and column indices. One example of a data format (representation) for representing sparse matrix 110 is the Coordinate (COO) data format. Another example of the data format (representation) for representing sparse matrix 110 is the Compressed Sparse Column (CSC) data format. Yet another example of the data format (representation) for representing sparse matrix 110 is the Compressed Sparse Row (CSR) data format. In an implementation using the CSR data format, a row pointer of row pointers 120 stores the index of the first non-zero element in a corresponding row within the packed, contiguous storage of the non-zero elements in element values 124. This index also points to the corresponding column offset within column offsets 122. Column offsets 122 store the column offsets of non-zero elements within a corresponding row. Element values 124 store the values of the non-zero elements of the rows of sparse matrix 110.

The CSR data format reduces the memory data storage and memory data bandwidth requirements of sparse matrix 110. However, the CSR data format also provides irregularity in memory access patterns by utilizing multiple levels of indirection such as indirections 150. The indirections 150 make it difficult to achieve high performance on processing circuit 140 where the parallel data microarchitecture of compute circuits 144A and 144B are designed for highly regular workloads and memory access patterns. Further, since the number of non-zero elements per row in sparse matrix 110 can vary widely, utilizing a single parallel processing algorithm for each stage of processing of the parallel data application is often inefficient. For sparse matrix vector multiplication (SpMV) operations, a first algorithm that assigns one parallel data thread to process each row of sparse matrix 110 performs poorly due to long tail latencies when row lengths vary. A second algorithm that uses a full workgroup to process each row suffers from poor device occupancy of parallel execution lanes of compute circuits 144A and 144B when processing rows with short row lengths.

Rather than use either of the above two algorithms, processing circuit 140 executes instructions that use an algorithm that begins with classifier kernel 130 and follows one of two paths. A first path executes, by processing circuit 140, the instructions of long rows multiplication kernels 134 when classifier kernel 130 determines a row of sparse matrix 110 is a long row. A second path executes, by processing circuit 140, the instructions of preprocessing kernels 132 followed by short rows multiplication kernels 136 when classifier kernel 130 determines a row of sparse matrix 110 is a short row. When executing the instructions of classifier kernel 130, a compute circuit of compute circuits 144A and 144B concurrently generates the classifications of a subset of rows of sparse matrix 110. In an implementation, the number of rows in the subset of rows having classifications generated concurrently is equal to the number of parallel lanes of execution of this compute circuit of compute circuits 144A and 144B. In other words, the number of rows in the subset of rows is equal to the number of threads in a wavefront supported by processing circuit 140 and each thread processes a corresponding row of the subset of rows.

In another implementation, each thread processes two or more corresponding rows of the subset of rows, and accordingly, the number of rows of the subset of rows is greater than the number of parallel lanes of execution of this compute circuit of compute circuits 144A and 144B. In an implementation, compute circuit 144A includes eight vector processing circuits, each with 64 parallel lanes of execution, and each thread processes four rows. Therefore, compute circuit 144A concurrently generates classifications for 2,048 rows (8×64×4=2,048). In other words, compute circuit 144A simultaneously executes 2,048 classification operations where each classification operation specifies whether a corresponding row is a long row or a short row based on a comparison of the row length threshold and the number of non-zero elements in the corresponding row. In some implementations, each of compute circuits 144A and 144B concurrently generates the row classifications of corresponding rows. In an implementation, the row classification specifies a row of sparse matrix 110 is a short row when the row length of the row is less than or equal to the row length threshold (threshold number of non-zero elements in the row). The row length threshold can also be referred to as the threshold length. The row classification specifies a row of sparse matrix 110 is a long row when the row length of the row is greater than the threshold length.

When compute circuit 144A executes the classifier kernel 130 and when a row of sparse matrix 110 is specified as a long row by classifier kernel 130, the corresponding lane of execution of compute circuit 144A generates a corresponding long row multiplication kernel 134 to send to scheduler 142. When compute circuit 144A executes the classifier kernel 130 and when a row of sparse matrix 110 is specified as a short row by classifier kernel 130, compute circuit 144A generates a corresponding preprocessing kernel 132 for processing one or more consecutive short rows. As used herein, an “island” refers to one or more short rows at the beginning of sparse matrix 110 prior to the first long row of sparse matrix 110, one or more short rows between two consecutive long rows of sparse matrix 110, or one or more short rows at the end of sparse matrix 110 after the last long row of sparse matrix 110. Preprocessing kernel 132 processes the island classified by compute circuit 144A executing classifier kernel 130.

In an implementation, the lane of execution of compute circuit 144A that generates preprocessing kernel 132 is the lane that identifies a short row at the beginning of the island (the one or more consecutive short rows). In some implementations, other lanes of execution of compute circuit 144A that classified other short rows of the island send corresponding information to this lane to generate preprocessing kernel 132. In an implementation, the corresponding information includes a row identifier (ID) or row index and a size (length) of the corresponding row. In other implementations, the lane that identifies the short row at the beginning of the island generates preprocessing kernel 132 with no further information from other lanes. At a later time, the assigned lane that receives preprocessing kernel 132 uses the metadata of preprocessing kernel 132 and the representation of sparse matrix 110 to execute preprocessing kernel 132 and execute the partitioning operations that group short rows together for subsequent matrix multiplication operations. As described earlier, the representation of sparse matrix 110 includes addresses that point to the data storage locations that store row pointers 120, column offsets 122 and element values 124 (of FIG. 1). Compute circuit 144A sends the preprocessing kernel 132 to scheduler 142. The subsequent overlapped execution of the preprocessing kernels 132, the long rows multiplication kernels 134, and the short rows multiplication kernels 136 increases the throughput of processing circuit 140 and increases the performance of the parallel data application relying on the matrix multiplication that uses the dense vector and sparse matrix 110.

By receiving kernels from lanes of execution of compute circuits 144A-144B, scheduler 142 receives kernels of a workload from a host processing circuit (not shown), such as a general-purpose central processing unit (CPU), and from the parallel lanes of execution of compute circuits 144A-144B. In some implementations, to send the corresponding long row multiplication kernel 134 to scheduler 142, the parallel lane of execution of compute circuit 144A utilizes a dispatch application programming interface (API) in the parallel data application. Therefore, processing circuit 140 generates a workload on its own without involvement from the host processing circuit used to provide translated commands for processing circuit 140. To do so, processing circuit 140 supports work graphs.

As used herein, a “work graph” is a programming model that supports a parallel data processing circuit, such as processing circuit 140, to generate a workload on its own without involvement from the host processing circuit. In other words, the compute circuits of the parallel data processing circuit are capable of generating kernels independently of the host processing circuit and sending the generated kernels to a scheduling queue of a control circuit of the parallel data processing circuit. A work graph node is the generated workload or the generated kernel. A compute circuit of the parallel data processing circuit generates the kernel by executing a kernel launch operation corresponding to a dispatch application programming interface. An example is the Direct3D 12 graphics API that is part of DirectX. Work graphs include nodes that perform tasks and pass data to other nodes across graph edges. The task that a node executes can include a command such as a dispatch call, a single thread running a certain shader algorithm to be executed by a hardware shader (or one of compute circuits 144A-144B), or a group of threads running the same shader algorithm. The configuration of the nodes is referred to as the “launch mode” and allows a broadcast launch for multiple threads and an individual thread launch. When threads are collected into a wavefront, each thread can have its own input data independent of other threads.

To launch a node, a record of data is created for the node by the producer (e.g., parallel lane of execution of one of compute circuits 144A-144B), and the node is launched in a chosen launch mode. The scheduler 142 determines the consumer (e.g., parallel lane(s) of execution of one of compute circuits 144A-144B) and dispatches the node to the consumer. Each of the producer and the consumer is within processing circuit 140. When processing circuit 140 utilizes work graphs, processing circuit 140 performs fine-grained memory management, which supports algorithms with dynamic work expansion, reduces or removes the use of persistent threads, removes the host processing circuit from accidentally having processing circuit 140 run out of work early, and removes the host processing circuit from guessing resource allocation of processing circuit 140 for a workload.

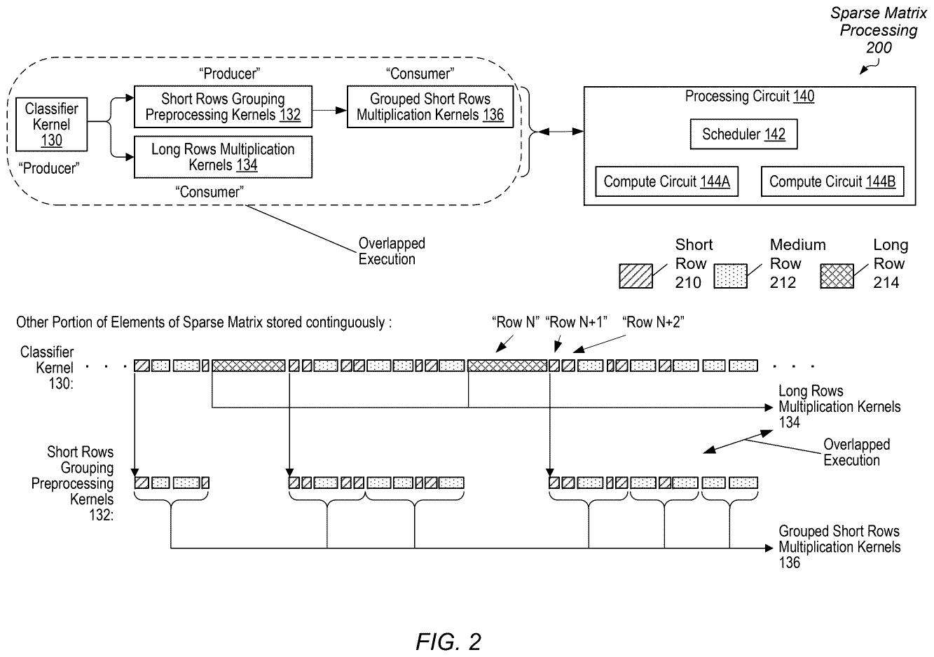

Turning now to FIG. 2, a generalized diagram is shown of sparse matrix processing 200 that performs efficient dynamic scheduling of kernels in a processing circuit. Circuitry and components previously described are numbered identically. As shown, the non-zero elements of a sparse matrix are stored in a packed, contiguous manner. In an implementation, the sparse matrix is sparse matrix 110 (of FIG. 1) that includes a number of rows and a number of elements per row based on design requirements, rather than the four elements per row shown in the illustrated implementation. For example, in other implementations, sparse matrix 110 can include millions of rows and hundreds of elements per row or thousands of elements per row or tens of thousands of elements per row. The shadings of boxes match for non-zero elements of the same row. The multiple rows include short rows 210, medium rows 212 and long rows 214. Although a third type of row, such as medium row 212, is shown, when executing classifier kernel 130, processing circuit 140 classifies rows as either being a long row (row length is greater than a length threshold) or a short row (row length is less than or equal to the length threshold). The medium row 212 has a length less than or equal to the length threshold but is shown to be a row that has a row length greater than the short row 210 in order to illustrate various row lengths in the sparse matrix. In various implementations, the parallel lanes of execution of compute circuit 144A (or compute circuit 144B) concurrently process each of the rows of the shown portion of sparse matrix 110. In an implementation, compute circuit 144A has four vector processing circuits, each with 64 parallel lanes of execution. Therefore, compute circuit 144A concurrently executes classifier kernel 130 on 256 rows of sparse matrix 110. For example, the classifier kernel 130 is launched with one thread per row.

Moving from left to right in the portion of the sparse matrix that is shown, there are four rows prior to a long row 214 such as a left-most short row 210, two medium rows 212 and another short row 210. After the first left-most long row 214, there are ten rows before the next long row 214. The ten rows include two short rows 210, a medium row 212, two more short rows 210, two medium rows 212, two short rows 210 and a medium row 212. After the second long row 214, there are ten more rows shown. As described earlier, an “island” refers to one or more short rows 210 or medium rows 212 at the beginning of the sparse matrix prior to the first long row 214 of the sparse matrix, one or more short rows 210 or medium rows 212 between two consecutive long rows 214 of the sparse matrix, or one or more short rows 210 or medium rows 212 at the end of the sparse matrix after the last long row 214 of the sparse matrix. Each generated preprocessing kernel 132 later processes rows within a corresponding island of short rows 210 (and/or medium rows 212).

In an implementation, classifier kernel 130 is launched with each thread assigned to process (classify) one row. In other implementations, classifier kernel 130 is launched with each thread assigned to process (classify) two or more rows. Each thread executing classifier kernel 130 checks whether the length of a corresponding row exceeds the length threshold. For example, when compute circuit 144A (or compute circuit 144B) executes the classifier kernel 130 and when a row of the sparse matrix is specified as a short row 210 or a medium row 212 by classifier kernel 130 at the start of an island, the given lane of execution of the vector processing circuit of compute circuit 144A generates a corresponding preprocessing kernel 132 to send to scheduler 142.

As described earlier, in some implementations, other lanes of execution of the vector processing circuit of compute circuit 144A that classified other short rows of the island send corresponding information to this given lane to generate preprocessing kernel 132. In an implementation, the corresponding information includes a row identifier (ID) or row index and a size (length) of the corresponding row. In other implementations, the given lane that identifies the short row at the beginning of the island generates preprocessing kernel 132 with no further information from other lanes. At a later time, the assigned lane that receives preprocessing kernel 132 uses the metadata of preprocessing kernel 132 and the representation of the sparse matrix, such as sparse matrix 110, to execute preprocessing kernel 132 and execute the partitioning operations that group short rows together for subsequent matrix multiplication operations. As described earlier, the representation of sparse matrix 110 includes addresses that point to the data storage locations that store row pointers 120, column offsets 122 and element values 124 (of FIG. 1). Although the illustrated implementation of row pointers 120, column offsets 122 and element values 124 represent an implementation of sparse matrix 110 with four elements per row, other implementations of row pointers 120, column offsets 122 and element values 124 represent an implementation of sparse matrix 110 that includes another number of rows and elements per row based on design requirements. For example, in other implementations, row pointers 120, column offsets 122 and element values 124 represent an implementation of sparse matrix 110 that includes millions of rows and hundreds of elements per row or thousands of elements per row or tens of thousands of elements per row.

In various implementations, preprocessing kernel 132 includes an indication of the type of operations or tasks to perform for preprocessing. In some implementations, when a vector processing circuit of compute circuit 144A executes the classifier kernel 130, the vector processing circuit uses break markers in fixed size intervals to force the termination of an island to ensure that the later preprocessing can be parallelized even if there is no long row in sparse matrix 110. The vector processing circuit terminates building the preprocessing kernel 132 when the end of sparse matrix 110 is reached, when a break marker is reached, or when a long row is reached. The corresponding rows can be stored in a stack in a local data store (LDS) and submitted as a work graphics payload to a subsequent node of the work graph such as a stream node (consumer node). The corresponding threads are included in a coalesced submission. Alternatively, the corresponding rows are data used by a preprocessing compute kernel with a size less than or equal to a workgroup.

When compute circuit 144A executes the classifier kernel 130 and when a row of sparse matrix 110 is specified as a long row by classifier kernel 130, such as the first long row 214, the corresponding lane of execution of compute circuit 144A generates a corresponding long row multiplication kernel 134 to send to scheduler 142. In some implementations, the long row multiplication kernel 134 includes addresses that point to the data storage locations that store row pointers 120, column offsets 122 and element values 124 (of FIG. 1). The long row multiplication kernel 134 also includes the row indices of the long row. In some implementations, the long row multiplication kernel 134 also includes a total size of the long row. In various implementations, scheduler 142 dispatches kernels to compute circuits 144A-144B and any other computing resources of processing circuit 140 optimized for different row lengths. Scheduler 142 determines which computing resource to use for a particular kernel based on the row length(s) of the corresponding row(s). For example, in an implementation, processing circuit 140 includes shaders (shader engines or compute circuits such as compute circuits 144A-144B) that are optimized for different row lengths.

One or more compute circuits execute the long row multiplication kernel 134. For example, the long row 214 can have a size greater than the size of a workgroup. In one example, the long row 214 has a number of non-zero elements greater than the number of threads corresponding to the size of a workgroup. The one or more compute circuits can perform a coalesced load operation for the values of the corresponding non-zero elements of sparse matrix 110, multiply these values by the input dense vector, and reduce the individual results for each row in the local data store or other data storage location before performing a single store operation for the final result. The long row multiplication kernel 134 can be a consumer node in the work graph, or alternatively, the long row multiplication kernel 134 includes one or more compute kernels, each performing the matrix multiplication operation at the granularity of a work group. The one or more compute circuits execute the long row multiplication kernel 134 concurrently as other compute circuits execute the preprocessing kernels 132. The subsequent overlapping execution of the preprocessing kernels 132, the long rows multiplication kernels 134, and the short rows multiplication kernels 136 increases the throughput of processing circuit 140 and increases the performance of the parallel data application relying on the matrix multiplication that uses the dense vector and sparse matrix 110.

The preprocessing kernels 132 segment corresponding islands into consecutive blocks of rows that can be consumed by the short rows multiplication kernels 136. In an implementation, the vector processing circuit of compute circuit 144A (or compute circuit 144B) segments an island into blocks with each block having a size no larger than the size of a workgroup. The vector processing circuit generates a corresponding short rows multiplication kernel 136 for each workgroup. In an implementation, the corresponding short rows multiplication kernel 136 is a consumer node of the work graph, whereas in another implementation, the corresponding short rows multiplication kernel 136 is a compute kernel to dispatch to one of the compute circuits 144A-144B. The overlapped execution of preprocessing kernels 132, the long rows multiplication kernels 134, and the short rows multiplication kernels 136 increases the throughput of processing circuit 140 and the performance of the parallel data application relying on the matrix multiplication that uses the dense vector and sparse matrix 110.

Similar to the long row multiplication kernel 134, the short rows multiplication kernels 136 performs a coalesced load operation for the values of the corresponding non-zero elements of sparse matrix 110, multiply these values by the input dense vector, and reduce the individual results for each row in the local data store or other data storage location before performing multiple store operations of the final results. The short rows multiplication kernels 136 can be a consumer node in the work graph, or alternatively, the short rows multiplication kernels 136 includes a compute kernel.

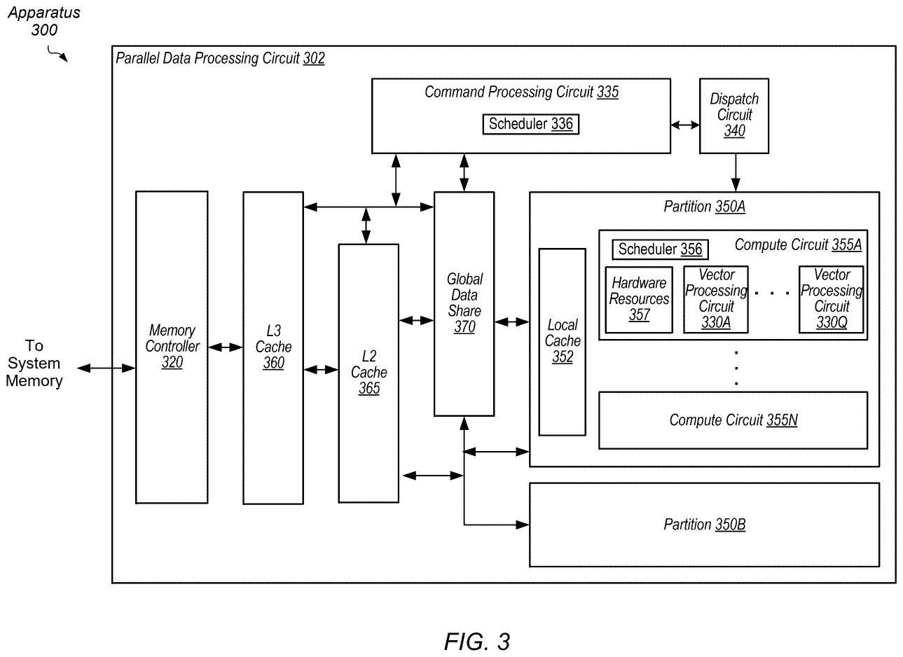

Referring to FIG. 3, a generalized diagram is shown of an apparatus 300 that performs efficient dynamic scheduling of kernels in a processing circuit. In various implementations, apparatus 300 includes parallel data processing circuit 302 with an interface to system memory. In some implementations, parallel data processing circuit 302 is a graphics processing unit (GPU). In other implementations, parallel data processing circuit 302 is an accelerator device or accelerator circuit used to execute a variety of parallel data applications. For example, apparatus 300 executes any of various types of highly parallel data applications. As part of executing an application, a host processing circuit, such as a CPU (not shown), launches kernels to be executed by the parallel data processing circuit 302. The command processing circuit 335 receives kernels from the host processing circuit and determines when dispatch circuit 340 dispatches wavefronts of these kernels to the compute circuits 355A-355N. In some implementations, apparatus 300 utilizes work graphs, and as a result, performs fine-grained memory management, which supports algorithms with dynamic work expansion, reduces or removes the use of persistent threads, removes the host processing circuit from accidentally having apparatus 300 run out of work early, and removes the host processing circuit from guessing resource allocation of apparatus 300 for a workload.

Multiple processes of a highly parallel data application provide work to be executed on compute circuits 355A-355N. The parallel data processing circuit 302 includes at least the command processing circuit (or command processor) 335, dispatch circuit 340, compute circuits 355A-355N, memory controller 320, global data share 370, shared level two (L2) cache 365, and level two (L3) cache 360. It should be understood that the components and connections shown for the parallel data processing circuit 302 are merely representative of one type processing circuit and do not preclude the use of other types of processing circuits for implementing the techniques presented herein. The apparatus 300 also includes other components which are not shown to avoid obscuring the figure. In other implementations, parallel data processing circuit 302 includes other components, omits one or more of the illustrated components, has multiple instances of a component even if only one instance is shown in the apparatus 300, and/or is organized in other suitable manners. Also, each connection shown in apparatus 300 is representative of any number of connections between components. Additionally, other connections can exist between components even if these connections are not explicitly shown in apparatus 300.

In an implementation, the memory controller 320 directly communicates with each of the partitions 350A-350B and includes circuitry for supporting communication protocols and queues for storing requests and responses. Threads within wavefronts executing on compute circuits 355A-355N read data from and write data to the cache 352, vector general-purpose registers, scalar general-purpose registers, and when present, the global data share 370, the shared L2 cache 365, and the L3 cache 360. When present, it is noted that the shared L2 cache 365 can include separate structures for data and instruction caches. It is also noted that global data share 370, shared L2 cache 365, L3 cache 360, memory controller 320, system memory, and cache 352 (L1 cache) can collectively be referred to herein as a “cache memory subsystem”.

In various implementations, the circuitry of partition 350B is a replicated instantiation of the circuitry of partition 350A. In some implementations, each of the partitions 350A-350B is a chiplet. As used herein, a “chiplet” is a semiconductor die (or die) fabricated separately from other dies and then interconnected with these other dies to form a single integrated circuit. In an implementation, cache 352 represents a last level shared cache structure within partition 350A. Additionally, each of the multiple compute circuits 355A-355N includes vector processing circuits 330A-330Q, each with circuitry of multiple parallel computational lanes of simultaneous execution. These parallel computational lanes operate in lockstep. In various implementations, the data flow within each of the lanes is pipelined. Pipeline registers are used for storing intermediate results and circuitry for arithmetic logic units (ALUs) perform integer arithmetic, floating-point arithmetic, Boolean logic operations, branch condition comparisons and so forth. These components are not shown for ease of illustration. Each of the ALUs within a given row across the lanes includes the same circuitry and functionality, and operates on the same instruction, but different data, such as a different data item, associated with a different thread.

In addition to the vector processing circuits 330A-330Q, compute circuit 355A also includes the hardware resources 357. The hardware resources 357 include at least an assigned number of vector general-purpose registers (VGPRs) per thread, an assigned number of scalar general-purpose registers (SGPRs) per wavefront, and an assigned data storage space of a local data store per workgroup. Each of the compute circuits 355A-355N receives wavefronts from dispatch circuit 340 and stores the received wavefronts in an instruction buffer of a corresponding local dispatch circuit (not shown). A local scheduler 356 within compute circuits 355A-355N schedules instructions of these wavefronts to be dispatched from the local dispatch circuits to the vector processing circuits 330A-330Q. In various implementations, scheduler 356 has the same functionality as scheduler 105 (of FIG. 1). Cache 352 can be the last level shared cache structure of partition 350A.

In some implementations, apparatus 300 includes shaders (shader engines or other hardware) that are optimized for different row lengths of rows of a matrix such as sparse matrix 110 (of FIG. 1). Therefore, one or more of scheduler 336 and dispatch circuit 340 schedules dispatch of compute kernels and/or nodes of a work graph based on the corresponding row lengths. Additionally, in some implementations, parallel lanes of execution of vector processing circuits 330A-330Q execute the classifier kernel 130 (of FIGS. 1-2) and, based on row lengths of the rows of a sparse matrix, generate a corresponding long row multiplication kernel 134 (of FIGS. 1-2) to send to scheduler 336 or generate a corresponding preprocessing kernel 132 (of FIGS. 1-2) to send to scheduler 336. Therefore, as one or more of the compute circuits 355A-355N execute the long row multiplication kernel 134, another one or more of compute circuits 355A-355N execute the preprocessing kernel 132. The overlapped execution of the preprocessing kernels 132, the long rows multiplication kernels 134, and the short rows multiplication kernels 136 increases the instruction throughput of apparatus 300 and increases the performance of the parallel data application relying on the matrix multiplication that uses the dense vector and sparse matrix 110 (of FIG. 1).

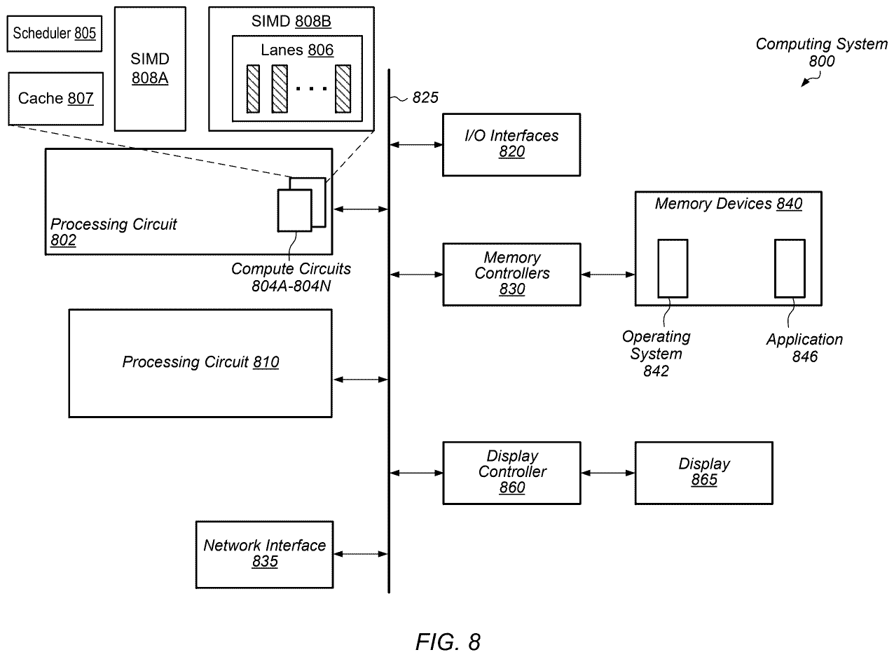

For methods 400-700, a computing system includes multiple processing circuits. Examples of the host processing circuit of the multiple processing circuits are host processing circuit 810 (of FIG. 8). Examples of the accelerator circuit of the multiple processing circuits are processing circuit 140 (of FIGS. 1-2), parallel data processing circuit 302 (of FIG. 3), and processing circuit 802 (of FIG. 8). For the methods 400-700, the multiple processing circuits execute a variety of types of parallel data applications such as computational workloads for molecular dynamics, workloads for graphics algorithms that rely on linear algebra (e.g. GraphBLAS API), workloads that use general-sparsity in a variety of types of machine learning (ML) models, workloads that use sparse matrix vector multiplication (SpMV) in High Performance Computing (HPC) applications, and so forth. In various implementations, the accelerator circuit for methods 400-800 utilizes work graphs, and as a result, performs fine-grained memory management, which supports algorithms with dynamic work expansion, reduces or removes the use of persistent threads, removes the host processing circuit from accidentally having the accelerator circuit run out of work early, and removes the host processing circuit from guessing resource allocation of the accelerator circuit for a workload.

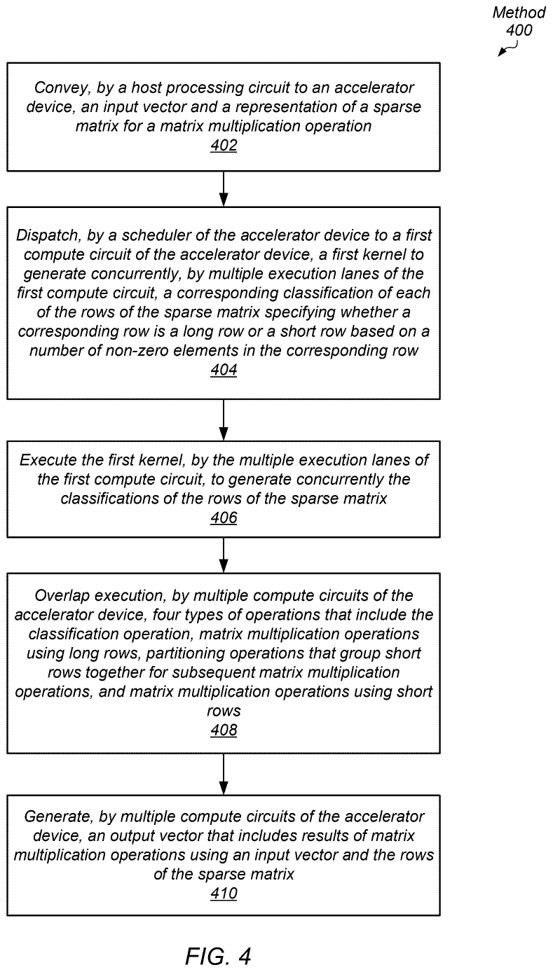

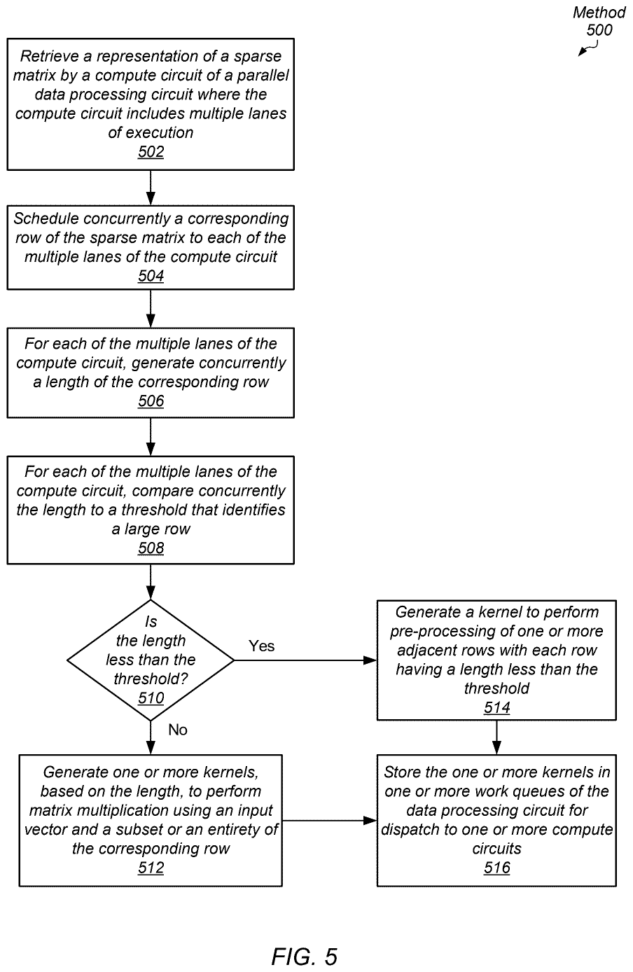

Referring to FIG. 4, a generalized diagram is shown of a method 400 for performing efficient dynamic scheduling of kernels in a processing circuit. For purposes of discussion, the steps in this implementation are shown in sequential order (as well as in FIGS. 5-7). However, in other implementations some steps occur in a different order than shown, some steps are performed concurrently, some steps are combined with other steps, and some steps are absent.

A host processing circuit conveys to an accelerator device, an input vector and a representation of a sparse matrix for a matrix multiplication operation (block 402). In some implementations, the host processing circuit provides address that point to the data storage locations that store row pointers 120, column offsets 122 and element values 124 (of FIG. 1). A scheduler of the accelerator device dispatches to a first compute circuit of the accelerator device, a first kernel to concurrently generate, by multiple execution lanes of the first compute circuit, a corresponding classification of each of the rows of the sparse matrix specifying whether a corresponding row is a long row or a short row based on a number of non-zero elements in the corresponding row (block 404). In an implementation, the first kernel has the format and functionality as classifier kernel 130 (of FIG. 1).

The multiple execution lanes of the first compute circuit execute the first kernel to generate concurrently the classifications of the rows of the sparse matrix (block 406). The multiple compute circuits of the accelerator device overlap execution of four types of operations that include classifying operations that classify rows as short rows or long rows, matrix multiplication operations using long rows, partitioning operations that group short rows together for subsequent matrix multiplication operations, and the matrix multiplication operations using short rows (block 408). The overlapped execution of the four types of operations increases the throughput of the accelerator device and increases the performance of the parallel data application relying on the matrix multiplication that uses the input vector and the sparse matrix. The multiple compute circuits of the accelerator device generate an output vector that includes results of matrix multiplication operations using an input vector and the rows of the sparse matrix (block 410).

Turning now to FIG. 5, a generalized diagram is shown of a method 500 for performing efficient dynamic scheduling of kernels in a processing circuit. A compute circuit of a parallel data processing circuit retrieves a representation of a sparse matrix where the compute circuit includes multiple lanes of execution (block 502). The compute circuit concurrently schedules a corresponding row of the sparse matrix to each of the multiple lanes of the compute circuit (block 504). For each of the multiple lanes of the compute circuit, the compute circuit concurrently generates a length of the corresponding row (block 506). For each of the multiple lanes of the compute circuit, the compute circuit concurrently compares the length to a threshold that identifies a large row (block 508).

If the length is equal to or greater than the threshold (“no” branch of the conditional block 510), then the compute circuit generates one or more kernels, based on the length, to perform matrix multiplication using an input vector and a subset or an entirety of the corresponding row (block 512). The one or more kernels can be compute kernels or nodes of a work graph. In some implementations, the one or more kernels have the format and functionality of long row multiplication kernel 134 (of FIGS. 1-2). Otherwise, if the length is less than the threshold (“yes” branch of the conditional block 510), then the compute circuit generates a kernel to perform pre-processing of one or more adjacent rows (an island) with each row having a length less than the threshold (block 514). In an implementation, the kernel has the format and functionality of preprocessing kernel 132 (of FIGS. 1-2). In various implementations, the lane of execution of a vector processing circuit of the compute circuit that generates the preprocessing kernel is the lane that identifies a short row at the beginning of the corresponding island. Afterward, the compute kernel stores the one or more kernels in one or more work queues of the data processing circuit for dispatch to one or more compute circuits (block 516). In an implementation, the scheduler dispatches the kernels to compute circuits based on the hardware of the compute circuits being optimized for the rows lengths (sizes) of rows being used in the kernels.

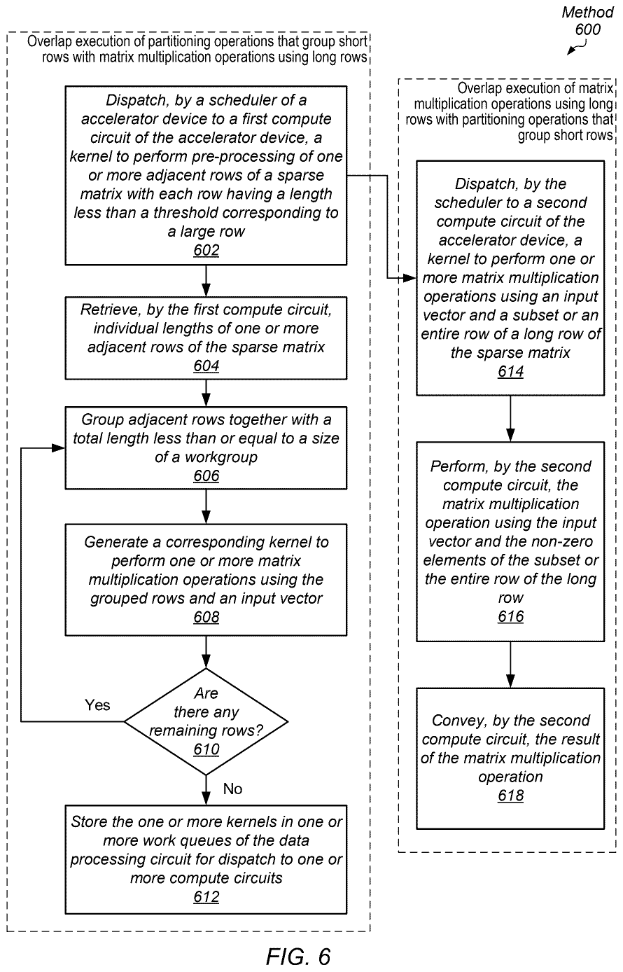

Referring to FIG. 6, a generalized diagram is shown of a method 600 for performing efficient dynamic scheduling of kernels in a processing circuit. A scheduler of an accelerator device dispatches to a compute circuit of the accelerator device, a kernel to perform pre-processing of one or more adjacent rows of a sparse matrix with each row having a length less than a threshold corresponding to a large row (block 602). In an implementation, the kernel has the format and functionality of preprocessing kernel 132 (of FIGS. 1-2). The compute circuit retrieves individual lengths of one or more adjacent rows of the sparse matrix (block 604). The compute circuit groups adjacent rows together with a total length less than or equal to the size of a workgroup (block 606). The compute circuit generates a corresponding kernel to perform one or more matrix multiplication operations using the grouped rows and an input vector (block 608). The kernel can be a compute kernel or a node of a work graph.

If there are remaining rows (“yes” branch of the conditional block 610), then control flow of method 600 returns to block 606 where the compute circuit groups adjacent rows together with a total length less than or equal to a size of a workgroup. Otherwise, if there are no remaining rows (“no” branch of the conditional block 610), then the compute circuit stores the one or more kernels in one or more work queues of the data processing circuit for dispatch to one or more compute circuits (block 612). The subsequent dispatch and execution of these one or more kernels overlaps execution of other kernels performing pre-processing of other short rows, performing matrix multiplication operations using long rows, and performing matrix multiplication operations using other short rows.

From block 602, the scheduler dispatches to a second compute circuit of the accelerator device, a kernel to perform one or more matrix multiplication operations using an input vector and a subset or an entire row of a long row of the sparse matrix (block 614). The second compute circuit performs the matrix multiplication operation using the input vector and the non-zero elements of the subset or the entire row of the long row (block 616). The second compute circuit conveys the result of the matrix multiplication operation (block 618). In an implementation, the scheduler dispatches the four types of kernels performing the four types of operations to compute circuits based on the hardware of the compute circuits being optimized for the row lengths (sizes) of rows being used in the kernels.

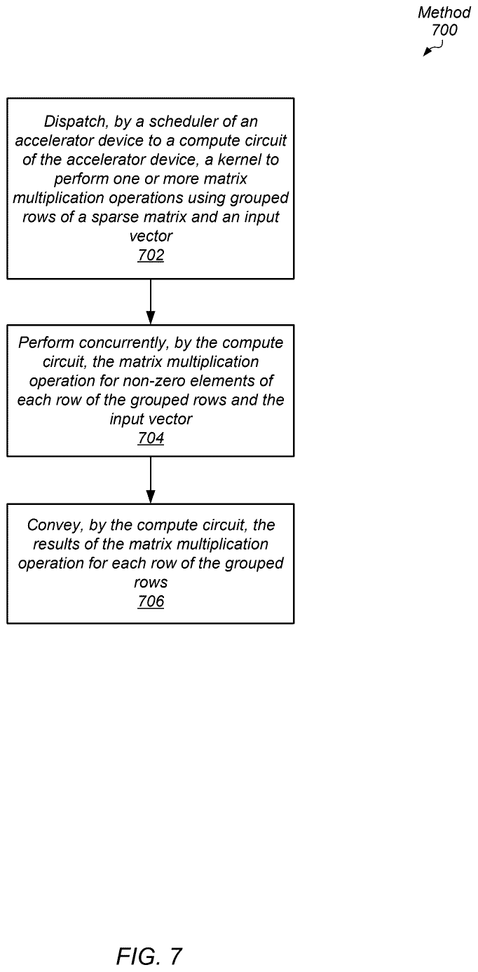

Turning now to FIG. 7, a generalized diagram is shown of a method 700 for performing efficient dynamic scheduling of kernels in a processing circuit. A scheduler of an accelerator device dispatches to a compute circuit of the accelerator device, a kernel to perform one or more matrix multiplication operations using grouped rows of a sparse matrix and an input vector (block 702). In some implementations, the scheduler assigns these operations to the compute circuit based on the hardware resources of the compute circuit are more optimized for the row sizes of the grouped rows than the hardware resources of at least one other compute circuit. In various implementations, each row of the grouped rows had been classified as a short row by another compute circuit executing a classifier kernel. This other compute circuit determined the size (length) of each row of the grouped rows, which includes the number of non-zero elements in a corresponding row, is less than or equal to a row length threshold. The compute circuit concurrently performs the matrix multiplication operation for non-zero elements of each row of the grouped rows and the input vector (block 704).

The compute circuit conveys the results of the matrix multiplication operation for each row of the grouped rows (block 706). In some implementations, the compute circuit performs the matrix multiplication operation for non-zero elements of each row of the grouped rows as other compute circuits of the accelerator device execute other types of operations. One type of other operations is the classifying operation that classifies rows as short rows or long rows. Another type of other operations is partitioning operations that group short rows together for subsequent matrix multiplication operations. Yet another type of other operations is the matrix multiplication operation using a long row. The overlapping execution of these four types of operations increases the throughput of the accelerator device and increases the performance of the parallel data application relying on the matrix multiplication that uses the input vector and the sparse matrix.

Turning now to FIG. 8, a generalized diagram is shown of a computing system 800 that performs efficient dynamic scheduling of kernels in a processing circuit. In an implementation, computing system 800 includes at least processing circuits 802 and 810, input/output (I/O) interfaces 820, bus 825, network interface 835, memory controllers 830, memory devices 840, display controller 860, and display 865. In other implementations, computing system 800 includes less components as shown, other additional components not shown, and/or computing system 800 is arranged differently. For example, power management circuitry, and phased locked loops (PLLs) or other clock generating circuitry are not shown for ease of illustration. In various implementations, the components of the computing system 800 are on the same die such as a system-on-a-chip (SOC). In other implementations, the components are individual dies in a system-in-package (SiP) or a multi-chip module (MCM). A variety of computing devices use the computing system 800 such as a desktop computer, a laptop computer, a server computer, a tablet computer, a smartphone, a gaming device, a smartwatch, and so on.

Processing circuits 802 and 810 are representative of any number of processing circuits which are included in computing system 800. In an implementation, processing circuit 810 is a general-purpose central processing unit (CPU) used as a host processing circuit in computing system 800. In one implementation, processing circuit 802 is a parallel data processing circuit with a highly parallel data microarchitecture, such as a GPU. The processing circuit 802 can be a discrete device, such as a dedicated GPU (dGPU), or the processing circuit 802 can be integrated (an iGPU) in the same package as another processing circuit. Other parallel data processing circuits that can be included in computing system 800 include digital signal processing circuits (DSPs), field programmable gate arrays (FPGAs), application specific integrated circuits (ASICs), accelerator devices or accelerator circuits, an embedded inference processing unit (EIPU) or an embedded inference processing circuit, an artificial intelligence (AI) accelerator processing circuit (an accelerator device), a neural processing unit (NPU) or a neural processing circuit, a tensor processing unit (TPU) or a tensor processing circuit, and so on.

In various implementations, the processing circuit 802 includes multiple, replicated compute circuits 804A-804N, each including similar circuitry and components such as a single instruction multiple data (SIMD) circuits 808A-808B, the cache 807, and hardware resources (not shown). The SIMD circuit 808A includes replicated circuitry of the circuitry of the SIMD circuit 808B. Although two SIMD circuits are shown, in other implementations, another number of SIMD circuits is used based on design requirements. As shown, the SIMD circuit 808B includes multiple, parallel computational lanes 806. Cache 807 can be used as a shared last-level cache in a compute circuit.

In various implementations, the data flow of SIMD circuit 808B is pipelined and the parallel execution lanes 806 operate in lockstep. In various implementations, the circuitry of each of the execution lanes 806 is an instantiated copy of circuitry for arithmetic logic units (ALUs) that perform integer arithmetic, floating-point arithmetic, Boolean logic operations, branch condition comparisons, and so forth. Each of the ALUs within a given row across execution lanes 806 includes the same circuitry and functionality, and operates on the same instruction, but different data, such as a different data item, associated with a different thread. Pipeline registers are used for storing intermediate results. A particular combination of the same instruction and a particular data item of multiple data items is referred to as a “work item.” A work item is also referred to as a thread. The multiple work items (or multiple threads) are grouped into thread groups, where a “thread group” is a partition of work executed in an atomic manner. In some implementations, a thread group includes instructions of a function call that operates on multiple data items concurrently. Each data item is processed independently of other data items, but the same sequence of operations of the subroutine is used. As used herein, a “thread group” is also referred to as a “work block” or a “wavefront.”

Tasks performed by execution lanes 806 can be grouped into a “workgroup” that includes multiple thread groups (or multiple wavefronts). Each of the compute circuits 804A-804N processes an assigned workgroup, and each of the SIMD circuits 808A-808B processes an assigned wavefront. The hardware, such as circuitry, of a scheduler (not shown) divides the workgroup into separate thread groups (or separate wavefronts) and assigns the wavefronts to be dispatched to SIMD circuits 808A-808B. In an implementation, such a scheduler is a command processing circuit of a GPU. In various implementations, scheduler 805 receives the wavefronts for one of the compute circuits 804A-804N, and schedules instructions of these wavefronts to be issued to SIMD circuits 808A-808B.

In some implementations, SIMD circuits 808A-808B have the same functionality as vector processing circuits 330A-330Q (of FIG. 3), and processing circuit 802 has the same functionality as parallel data processing circuit 302 (of FIG. 3). Therefore, in an implementation, processing circuit 802 includes shaders (shader engines or other hardware) that are optimized for different row lengths of rows of a matrix such as sparse matrix 110 (of FIG. 1). Scheduler 805 schedules dispatch of compute kernels and/or nodes of a work graph based on the corresponding row lengths. Additionally, in some implementations, parallel lanes of execution of SIMD circuits 808A-808B execute the classifier kernel 130 (of FIGS. 1-2) and based on row lengths of the rows of a sparse matrix, generate a corresponding long row multiplication kernel 134 (of FIGS. 1-2) to send to scheduler 805 or generate a corresponding preprocessing kernel 132 (of FIGS. 1-2) to send to scheduler 805. Therefore, as one or more of the compute circuits 804A-804N execute the long row multiplication kernel 134, another one or more of compute circuits 804A-804N execute the preprocessing kernel 132. The overlapping execution of preprocessing kernels 132, the long rows multiplication kernels 134 and the short rows multiplication kernels 136 increases the throughput of processing circuit 802 and increases the performance of the parallel data application relying on the matrix multiplication that uses the dense vector and sparse matrix 110 (of FIG. 1).

A local hierarchical cache memory subsystem of processing circuit 810 stores source data, intermediate results data, results data, and copies of data and instructions stored in memory devices 840. In some implementations, application 846 stored on memory devices 840 is a highly parallel data application that provides multiple kernels to be executed on the compute circuits 804A-804N. The high parallelism offered by the hardware of the compute circuits 804A-804N is used for real-time data processing. Examples of real-time data processing are rendering multiple pixels, image blending, pixel shading, vertex shading, and geometry shading. In such cases, each of the data items of a wavefront is a pixel of an image. The compute circuits 804A-804N can also be used to execute other threads that require operating simultaneously with a relatively high number of different data elements (or data items). Examples of these threads are threads for scientific, medical, entertainment, finance and encryption/decryption computations.

In some implementations, computing system 800 utilizes a communication fabric (“fabric”), rather than the bus 825, for transferring requests, responses, and messages between the processing circuits 802 and 810, the I/O interfaces 820, the memory controllers 830, the network interface 835, and the display controller 860. When messages include requests for obtaining targeted data, the circuitry of interfaces within the components of computing system 800 translates target addresses of requested data. In some implementations, the bus 825, or a fabric, includes circuitry for supporting communication, data transmission, network protocols, address formats, interface signals and synchronous/asynchronous clock domain usage for routing data.

Memory controllers 830 are representative of any number and type of memory controllers accessible by processing circuits 802 and 810. While memory controllers 830 are shown as being separate from processing circuits 802 and 810, it should be understood that this merely represents one possible implementation. In other implementations, one of memory controllers 830 is embedded within one or more of the processing circuits 802 and 810 or it is located on the same semiconductor die as one or more of processing circuits 802 and 810. Memory controllers 830 are coupled to any number and type of memory devices 840.

Memory devices 840 are representative of any number and type of memory devices. For example, the type of memory in memory devices 840 includes Dynamic Random Access Memory (DRAM), Static Random Access Memory (SRAM), NAND Flash memory, NOR flash memory, Ferroelectric Random Access Memory (FeRAM), or otherwise. Memory devices 840 store at least instructions of an operating system 842, one or more device drivers, and application 846. In some implementations, application 846 is a highly parallel data application such as a video graphics application, a shader application, or other. Copies of these instructions can be stored in a memory or cache device local to processing circuit 810 and/or processing circuit 802.

I/O interfaces 820 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB). Various types of peripheral devices (not shown) are coupled to I/O interfaces 820. Such peripheral devices include (but are not limited to) displays, keyboards, mice, printers, scanners, joysticks or other types of game controllers, media recording devices, external storage devices, and so forth. Network interface 835 receives and sends network messages across a network.

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high-level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware-based type emulator from such vendors as Cadence®, EVE®, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is

1. An apparatus comprising:
a plurality of compute circuits; and
a control circuit configured to:
receive, from a host processing circuit, a task to generate an output vector comprising results of matrix multiplication operations using an input vector and a plurality of rows of a sparse matrix; and
dispatch a plurality of kernels to the plurality of compute circuits to generate the output vector; and
wherein the plurality of compute circuits is configured to:
generate one or more kernels of the plurality of kernels independently of the host processing circuit; and
send the one or more kernels to the control circuit for dispatch.

2. The apparatus as recited in claim 1, wherein the plurality of compute circuits is configured to:
generate the one or more kernels by executing a kernel launch operation corresponding to a dispatch application programming interface; and
convey the one or more kernels to a scheduling queue of the control circuit.

3. The apparatus as recited in claim 1, wherein the plurality of compute circuits is configured to generate the output vector by overlapping execution of the matrix multiplication operations and execution of classification operations used to specify whether each row of the plurality of rows is a long row or a short row based on a number of non-zero elements in a corresponding row.

4. The apparatus as recited in claim 3, wherein:
one or more of the plurality of compute circuits is optimized for different row lengths, wherein a row length comprises the number of non-zero elements in a corresponding row; and
the control circuit is configured to dispatch the plurality of kernels to the plurality of compute circuits based on row lengths of rows of the plurality of rows being operated on the plurality of kernels.

5. The apparatus as recited in claim 3, wherein the plurality of compute circuits is configured to generate the output vector by further overlapping execution of collection operations that collect consecutive short rows together for subsequent concurrent matrix multiplication operations by a compute circuit of the plurality of compute circuits.

6. The apparatus as recited in claim 5, wherein:
each of a plurality of execution lanes of a given compute circuit of the plurality of compute circuits is configured to concurrently execute one of the classification operations; and
a first lane of the plurality of execution lanes is configured to generate a first kernel of the one or more kernels to perform matrix multiplication using an input vector and a subset or an entirety of a first row, responsive to a corresponding classification operation specifies the first row as the long row.

7. The apparatus as recited in claim 6, wherein a second lane of the plurality of execution lanes is configured to generate a second kernel of the one or more kernels to perform one of the collection operations for at least a second row, responsive to a corresponding classification operation specifies the second row as the short row.

8. A method, comprising:
conveying, by a host processing circuit to a parallel data processing circuit, a task to generate an output vector comprising results of matrix multiplication operations using an input vector and a plurality of rows of a sparse matrix;
dispatching, by a control circuit of the parallel data processing circuit, a plurality of kernels to a plurality of compute circuits of the parallel data processing circuit to generate the output vector;
generating, by the plurality of compute circuits, one or more kernels of the plurality of kernels independently of the host processing circuit; and
sending, by the plurality of compute circuits, the one or more kernels to the control circuit for dispatch.

9. The method as recited in claim 8, further comprising:
generating, by the plurality of compute circuits, the one or more kernels by executing a kernel launch operation corresponding to a dispatch application programming interface; and
conveying, by the plurality of compute circuits, the one or more kernels to a scheduling queue of the control circuit.

10. The method as recited in claim 8, further comprising generating, by the plurality of compute circuits, the output vector by overlapping execution of the matrix multiplication operations and execution of classification operations used to specify whether each row of the plurality of rows is a long row or a short row based on a number of non-zero elements in a corresponding row.

11. The method as recited in claim 10, wherein:
one or more of the plurality of compute circuits is optimized for different row lengths, wherein a row length comprises the number of non-zero elements in a corresponding row; and
the method further comprises dispatching, by the control circuit, the plurality of kernels to the plurality of compute circuits based on row lengths of rows of the plurality of rows being operated on the plurality of kernels.

12. The method as recited in claim 10, further comprising generating, by the plurality of compute circuits, the output vector by further overlapping execution of collection operations that collect consecutive short rows together for subsequent concurrent matrix multiplication operations by a compute circuit of the plurality of compute circuits.

13. The method as recited in claim 12, further comprising:
concurrently executing one of the classification operations by each of a plurality of execution lanes of a given compute circuit of the plurality of compute circuits; and
generating, by a first lane of the plurality of execution lanes, a first kernel of the one or more kernels to perform matrix multiplication using an input vector and a subset or an entirety of a first row, responsive to a corresponding classification operation specifies the first row as the long row.

14. The method as recited in claim 13, further comprising generating, by a second lane of the plurality of execution lanes, a second kernel of the one or more kernels to perform one of the collection operations for at least a second row, responsive to a corresponding classification operation specifies the second row as the short row.

15. A computing system comprising:
a parallel data processing circuit; and
a host processing circuit configured to convey, to the parallel data processing circuit, a task to generate an output vector comprising results of matrix multiplication operations using an input vector and a plurality of rows of a sparse matrix; and
wherein the parallel data processing circuit comprises:
a plurality of compute circuits; and
a control circuit configured to:
receive the task from the host processing circuit; and
dispatch a plurality of kernels to the plurality of compute circuits to generate the output vector; and
wherein the plurality of compute circuits is configured to:
generate one or more kernels of the plurality of kernels independently of the host processing circuit; and
send the one or more kernels to the control circuit for dispatch.

16. The computing system as recited in claim 15, wherein the plurality of compute circuits is configured to:
generate the one or more kernels by executing a kernel launch operation corresponding to a dispatch application programming interface; and
convey the one or more kernels to a scheduling queue of the control circuit.

17. The computing system as recited in claim 15, wherein the plurality of compute circuits is configured to generate the output vector by overlapping execution of the matrix multiplication operations and execution of classification operations used to specify whether each row of the plurality of rows is a long row or a short row based on a number of non-zero elements in a corresponding row.

18. The computing system as recited in claim 17, wherein:
one or more of the plurality of compute circuits is optimized for different row lengths, wherein a row length comprises the number of non-zero elements in a corresponding row; and
the control circuit is configured to dispatch the plurality of kernels to the plurality of compute circuits based on row lengths of rows of the plurality of rows being operated on the plurality of kernels.

19. The computing system as recited in claim 17, wherein the plurality of compute circuits is configured to generate the output vector by further overlapping execution of collection operations that collect consecutive short rows together for subsequent concurrent matrix multiplication operations by a compute circuit of the plurality of compute circuits.

20. The computing system as recited in claim 19, wherein:
each of a plurality of execution lanes of a given compute circuit of the plurality of compute circuits is configured to concurrently execute one of the classification operations; and
a first lane of the plurality of execution lanes is configured to generate a first kernel of the one or more kernels to perform matrix multiplication using an input vector and a subset or an entirety of a first row, responsive to a corresponding classification operation specifies the first row as the long row.
